(19) United States
(12) Patent Application Publication
(10) Pub. No.: US 2025/0015920 A1
(43) Pub. Date: Jan. 9, 2025

(54) TRANSMITTER, RECEIVER, AND METHOD FOR WIRELESS COMMUNICATIONS

(71) Applicant: INSTITUTE FOR INFORMATION INDUSTRY, TAIPEI (TW)

(72) Inventors: Hsien Tsung HSU, TAIPEI (TW); Pei Yu HUNG, TAIPEI (TW); Wen-Yao CHANG, TAIPEI (TW)

(21) Appl. No.: 18/508,256

(22) Filed: Nov. 14, 2023

Related U.S. Application Data
(60) Provisional application No. 63/525,364, filed on Jul. 6, 2023.

(51) Int. Cl. H04L 1/00; H04W 24/02

(52) U.S. Cl. CPC H04L 1/0033; H04L 1/001; H04W 24/02

(57) ABSTRACT

A transmitter for wireless communications includes an encoder, a normalizer, a binarizer, and a radio frequency (RF) circuit. The encoder is configured to encode a control message into a channel dimensional vector according to a channel dimension and the number of semantic fields by utilizing a training model. The control message includes at least one of control plane media access control layer information and control plane physical layer information. The normalizer is configured to normalize the channel dimensional vector to generate a normalized channel dimensional vector. The binarizer is configured to binarize the normalized channel dimensional vector to generate a fixed-point number. The RF circuit is configured to modulate the fixed-point number into an RF signal and transmit the RF signal.

### RELATED APPLICATIONS

This application claims priority to U.S. Provisional Application Ser. No. 63/525,364, filed Jul. 6, 2023, which is herein incorporated by reference.

### BACKGROUND

### Technical Field

The present disclosure relates to wireless communication technology, and more particularly to a transmitter, a receiver, and a method for wireless communications.

### Description of Related Art

5G New Radio (NR) is a recently developed radio access technology that supports high throughput, low latency, and high capacity communications. In 5G NR and similar wireless communication systems, the transmitting end usually encodes the data using channel encoding to resist channel transmission errors, so that the receiving end can successfully decode the encoded data into the correct data. However, due to the increase of bit error rate (BER) caused by channel noise, if the BER is too high, the receiving end will not be able to restore the data completely, resulting in waste of transmission resources and the burden of retransmission.

### SUMMARY

One aspect of the present disclosure directs to a transmitter for wireless communications. The transmitter includes an encoder, a normalizer, a binarizer, and a radio frequency (RF) circuit. The encoder is configured to encode a control message into a channel dimensional vector according to a channel dimension and the number of semantic fields by utilizing a training model. The control message includes at least one of control plane media access control (MAC) layer information and control plane physical layer information. The normalizer is configured to normalize the channel dimensional vector to generate a normalized channel dimensional vector. The binarizer is configured to binarize the normalized channel dimensional vector to generate a fixed-point number. The RF circuit is configured to modulate the fixed-point number into a RF signal and transmit the RF signal.

Another aspect of the present disclosure directs to a receiver for wireless communications. The receiver includes an RF circuit, a de-binarizer, and a decoder. The RF circuit is configured to receiver an RF signal and demodulate the RF signal into a fixed-point number. The de-binarizer is configured to de-binarize the fixed-point number to generate a channel dimensional vector. The decoder is configured to decode the channel dimensional vector into a control message according to a channel dimension and the number of semantic fields by utilizing a training model. The control message includes a control plane MAC layer message or a control plane physical layer message.

Yet another aspect of the present disclosure directs to a wireless communication method for a transmitting end. The communication method includes: encoding a control message into a channel dimensional vector according to a channel dimension and the number of semantic fields by utilizing a training model, in which the control message includes at least one of control plane MAC layer information and control plane physical layer information; normalizing the channel dimensional vector to generate a normalized channel dimensional vector; binarizing the normalized channel dimensional vector to generate a fixed-point number; and modulating the fixed-point number into a RF signal and transmitting the RF signal.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system according to some embodiments of the present disclosure.

FIG. 2 is a schematic diagram of wireless communications between a transmitting end and a receiving end in accordance with some embodiments of the present disclosure.

FIG. 3 is a schematic diagram of each stage block of a model training method in accordance with some embodiments of the present disclosure.

FIG. 4A is a schematic functional block diagram of a transmitter in accordance with some embodiments of the present disclosure.

FIG. 4B is a schematic functional block diagram of a receiver in accordance with some embodiments of the present disclosure.

FIG. 5 is a schematic diagram of each stage block of a control message transmission method in accordance with some embodiments of the present disclosure.

FIG. 6 is a flowchart of a wireless communication method in accordance with some embodiments of the present disclosure.

FIG. 7 is a schematic block diagram of an apparatus in accordance with some embodiments of the present disclosure.

### DETAILED DESCRIPTION

The detailed explanation of the present disclosure is described as follows. The described preferred embodiments are presented for purposes of illustrations and description, and they are not intended to limit the scope of the present disclosure.

Terms used herein are only used to describe the specific embodiments, which are not used to limit the claims appended herewith. Unless limited otherwise, the term “a,” “an,” “one” or “the” of the single form may also represent the plural form.

It will be understood that, although the terms “first” and “second” may be used herein to describe various elements, these elements should not be limited by these terms. These terms are only used to distinguish one element from another. In addition, the operative term “determine” used herein may be replaced with another operative term “generate” or “calculate”.

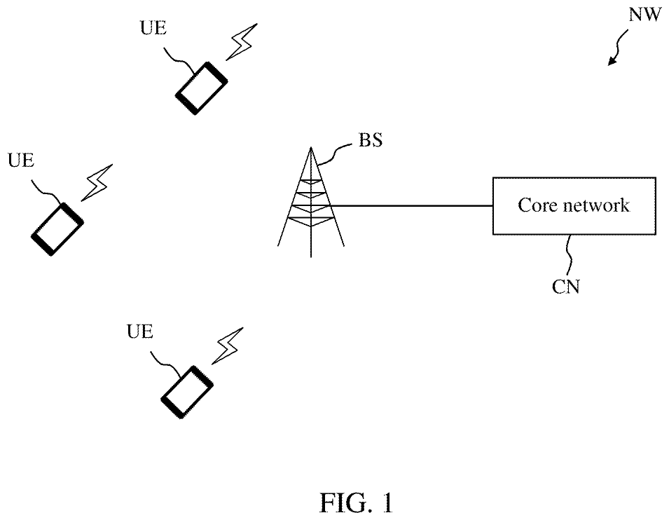

FIG. 1 is a schematic diagram of a wireless communication system 10 in accordance with some embodiments of the present disclosure. The wireless communication system 10 may be, for example, a fifth generation (5G) NR communication system, Beyond 5G (B5G) communication system, a sixth generation (6G) and/or other similar wireless communication system (e.g., evolution of any of the above systems). In the wireless communication system 10, a user equipment UE is connected to the network NW via the radio access network (RAN). The network NW includes a base station BS and a core network CN, where the base station BS is configured to provide the interface for the user equipment UE to access the RAN, and the core network CN is configured to provide network services for each of the user equipment UE and also provide a variety of core network functions.

In the wireless communication system 10, the user equipment UE and the base station BS are connected through a wireless interface. In the example of 5G NR communication system, the core network CN is also referred to as a 5G Core (5GC) Network or fourth generation (4G) Evolved Packet Core (EPC) network that supports 5G functions, and the base station BS is also referred to as a Next Generation NodeB (gNB), an Evolved Universal Terrestrial Radio Access Network (E-UTRAN) Evolved NodeB (eNB) or a next-generation evolved base station (ng-eNB), and the radio access network can be referred to as a Next-Generation RAN (NG-RAN) or an evolved universal terrestrial wireless access network that supports 5G functions.

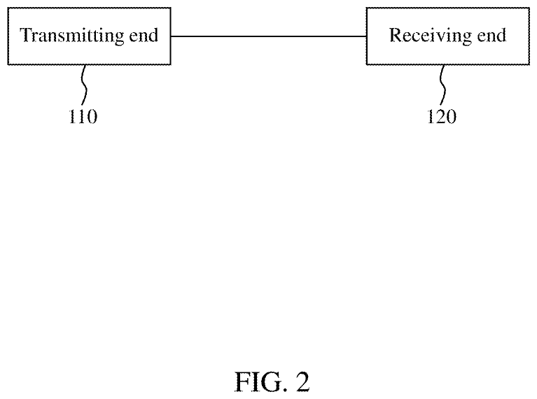

FIG. 2 is a schematic diagram of wireless communications between a transmitting end 110 and a receiving end 120 in accordance with some embodiments of the present disclosure. In FIG. 2, the transmitting end 110 and the receiving end 120 are communicatively connected via a wireless channel. The transmitting end 110 and the receiving end 120 may perform one-way transmission or two-way transmission, in which the message transmission from the transmitting end 110 to the receiving end 120 is a downlink transmission, while the message transmission from the receiving end 120 to the transmitting end 110 is an uplink transmission. Taking the wireless communication system 10 in FIG. 1 as an example, the transmitting end 110 and the receiving end 120 may be the base station BS and any user equipment UE in the wireless communication system 10, respectively.

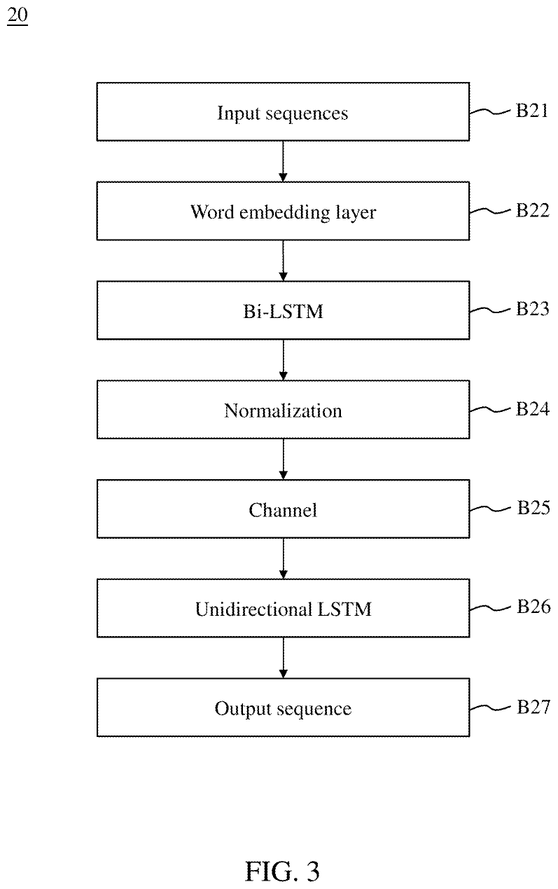

In the embodiments of the present disclosure, the transmitting end 110 and the receiving end 120 may adopt machine learning (e.g., deep learning, reinforcement learning, deep reinforcement learning, etc.) to generate a training model, and use the training model to conduct control message transmissions and receptions. In the following paragraphs, the schematic diagram of each stage block of a model training method 20 in FIG. 3 is incorporated to specifically elucidate the operations of the transmitting end 110 and the receiving end 120 the training phases. The stage blocks of the model training method 20 may be compiled into a program for execution.

In the stage of Block B21, a set of reference data (which may consist of all semantic descriptions of each semantic field in the control message) is selected, and the parameters (including but not limited to channel dimension, batch size, learning speed, feature dimension, epoch, signal-to-noise ratio, and loss function, etc.) of the training model are set. Then, the semantic sequences corresponding to the semantic fields of the set of reference data are converted into integer token sequences as input sequences, in which the conversion includes mapping each semantic description (e.g., a character or a word) in each of the semantic sequences to an integer token index and converting all integer token indices sequentially to the integer token sequences. Different semantic descriptions correspond to different integer token indices. The channel dimension may be set according to the number of semantic sequences in the set of reference data. For example, the channel dimension may be smaller (such as but not limited to 8) as the number of semantic sequences decreases; the channel dimension may be larger (such as but not limited to 256) as the number of semantic sequences increases.

In the stage of Block B22, the input sequences are converted into word embedding vectors with a high feature dimension by a word embedding layer (such as Word2Vec). The correlations between different semantic descriptions can be obtained through the word embedding vectors.

In the stage of Block B23, the word embedding vectors are compressed by the encoder of the transmitting end 110 into compression sequences according to the length of each word embedding vector of the input sequence, and the compressed sequences are inputted into the training model for processing. The utilized training model includes (e.g., may be) a bi-directional long-short term memory (Bi-LSTM) neural network model, another suitable neural network model, such as recurrent neural Network (RNN), a transformer, bidirectional encoder representations from transformers (BERT), a generative pre-trained transformer (GPT), a large language model (LLM), or a combination thereof. In the present disclosure embodiment, the training model utilized by the transmitting end 110 is exemplified by a Bi-LSTM neural network model which is used to perform Bi-LSTM network encoding in the training phase.

The Bi-LSTM neural network model is utilized to perform Bi-LSTM forward propagations on the compressed sequences to generate hidden states of the compressed sequences. Specifically, after each forward LSTM training, the final state of the forward LSTM is used as the initial state of the backward LSTM for subsequent forward LSTM training. During training, the forward and backward hidden states are respectively propagated to the corresponding backward and forward LSTM cells, the gradient of the training model is calculated, and the weights of the training model are updated through back propagation. By utilizing the Bi-LSTM training method, the contextual information between the previous and next semantic descriptions and the dependencies between the semantic descriptions in different input sequences can be extracted.

In the embodiments of the present disclosure, an activation function may be used in the training model to learn nonlinear relationships (e.g., between layers in the model) and increase nonlinear features.

Then, the forward and backward hidden states at the output of the Bi-LSTM neural network model are extracted, and these hidden states are connected through a fully connected layer to extract features, and these features are converted into channel dimension vectors represented by floating-point numbers. In the stage of Block B24, the transmitting end 110 normalizes the floating-point number of each channel dimension vector in a fixed range, so as to avoid excessive differences in the floating-point numbers between different features that affect the prediction ability of the training model. In the normalization on the output of each layer in the training model, the sum of the squared values of all channel dimension vectors is first calculated, then the square root of the sum of the square values is calculated, and then the corresponding normalized channel dimension vectors are calculated by multiplying the channel dimensional vectors by the square root.

In the stage of Block B25, after generating offsets on the input normalized channel dimension vectors, channel dimension vectors with offset are generated and then transmitted to the receiving end 120 through a simulated wireless channel. The simulated wireless channel may be an additive white Gaussian noise (AWGN) channel or some other suitable channel.

In some embodiments, the encoder of the transmitting end 110 includes a joint source-channel coding (JSCC) encoder which encodes the control message by combining source coding and channel coding to provide better anti-noise ability of physical transmissions.

In the stage of Block B26, the receiving end 120 receives the channel dimension vector, and then the decoder of the receiving end 120 progressively decodes the received channel dimension vector. The training model utilized by the decoder can be an LSTM neural network model, such as a unidirectional LSTM neural network model, another suitable neural network model, or a combination thereof. In the embodiments of the present disclosure, the training model utilized by the decoder is exemplified by a unidirectional LSTM neural network model which is used to perform unidirectional LSTM memory network decoding in the training phase. In the stage of Block B27, the decoder processes the channel dimension vector to sequentially generate semantic descriptions until all semantic descriptions are decoded to generate a semantic sequence as an output sequence, where the next semantic description at each time point is generated based on the previous input and hidden state. For example, the decoder may utilize the softmax function to represent the probability distribution of each generated candidate semantic sequence at the current time point, and select the candidate semantic sequence with the highest probability value as a resulting semantic sequence.

In some embodiments, the output of some neurons may be randomly set to zero during the decoding process using the dropout function. In brief, the outputs of a subset of neurons can be randomly set to zero for each batch size to force other nodes to learn more features, thereby reducing the dependence on a single node, and improving the generation ability of the training model.

Finally, the decoder of the receiving end 120 calculates the loss based on the cross-entropy (CE) between the candidate semantic sequences and the input sequences, and performs backward propagation on the calculated loss to update the model weights for calculating the gradients of all parameters in the training model. In some embodiments, to avoid the gradient explosion problem, the gradients may be clipped to a maximum value of 0.1. A smaller cross-entropy means a smaller loss, i.e., a better training model.

In some embodiments, the decoder of the receiving end 120 includes a JSCC decoder which decodes the channel dimension vectors by combining source decoding and channel decoding to increase the reliability of the decoded candidate semantic sequences.

The above training process is a complete epoch using a set of reference data and all candidate semantic sequences. In some embodiments, the weights of the training model may be stored after every 3 epochs. The training model with the minimum loss may be used for the transmitting end 110 and the receiving end 120 for actual wireless communications.

According to the present disclosure, in the training phase, the encoder and the decoder are synchronously trained with the same set of reference data respectively on the transmitting end 110 and the receiving end 120 to encode the semantic descriptions or features of the control message and transmit the encoded signal from the transmitting end 110 to the receiving end 120 through a physical layer channel, and the received signal is decoded into the control message by the receiving end 120. The semantic meaning and features can still be correctly restored in the case of a high BER (e.g., 3%). By adopting the above encoding method, the data can be further compressed to reduce the amount of data transmission. Moreover, the above encoding method is to extract semantic features from the control information for channel coding, which also helps to improve the error resistance. Therefore, even if noise or interference in the physical layer channel results in the transmission distortion, the receiving end can still accurately restore the original control message by decoding and extracting semantic features.

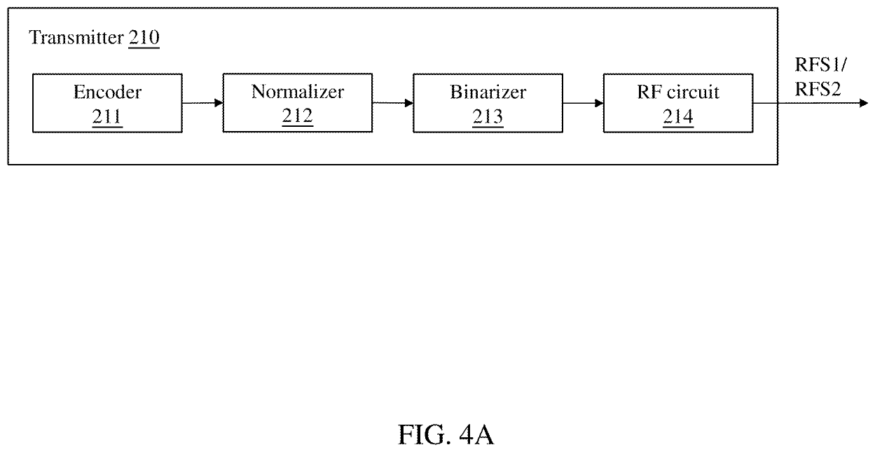

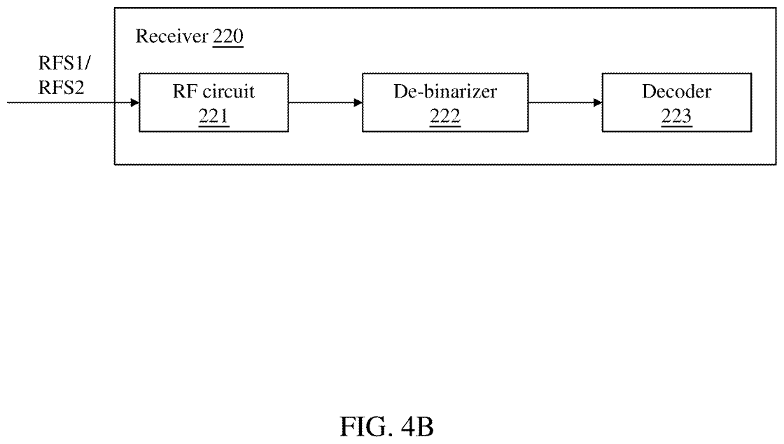

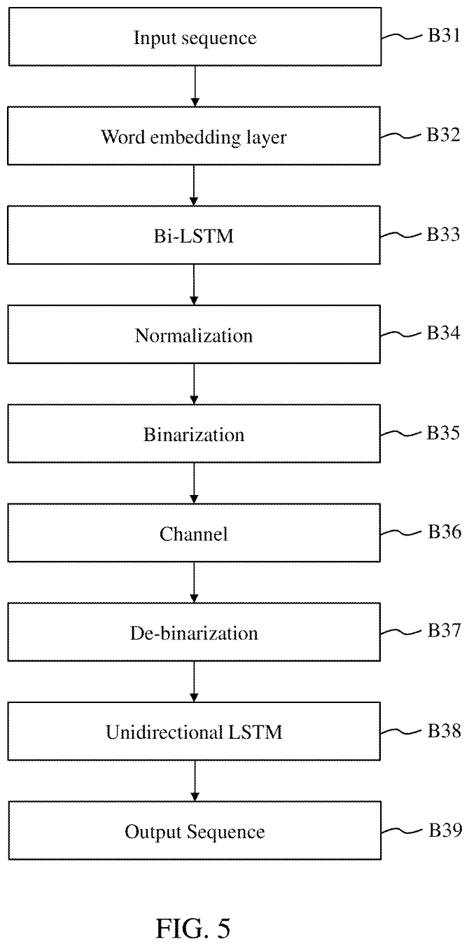

FIGS. 4A and 4B are schematic functional block diagrams of a transmitter 210 and a receiver 220 in accordance with some embodiments of the present disclosure, respectively. The transmitter 210 may be, for example, the base station BS in FIG. 1 or the transmitting end 110 in FIG. 2, and correspondingly the receiver 220 may be, for example, any user equipment UE in FIG. 1 or the receiving end 120 in FIG. 2. As shown in FIGS. 4A and 4B, the transmitter 210 includes an encoder 211, a normalizer 212, a binarizer 213, and an RF circuit 214, and the receiver 220 includes an RF circuit 221, a de-binarizer 222, and a decoder 223. In the following paragraphs, the schematic diagram of each stage block of a control message transmission method 30 in FIG. 5 is incorporated to specifically elucidate wireless communications using the transmitter 210 and the receiver 220. The stage blocks of the control message transmission method 30 may be compiled into a program for execution.

The encoder 211 is configured to select a set of reference data and utilize the training model to encode a control message into a channel dimension vector according to a channel dimension and the number of semantic fields. The control message may include control plane MAC layer information, control plane physical layer information, or a combination thereof. The control plane information may include downlink control information (DCI) as shown in Table 1 or other control information for configuring the receiving end 120, such as system information block (SIB) 6/7/8, earthquake and tsunami alarm system/commercial mobile alert service broadcast alarm notification information, control elements (CE) at MAC layer, etc.

Specifically, in the stage of Block B31, the encoder 211 firstly combines (e.g., denotes) the control message as a semantic sequence (e.g., according to a channel dimension), and utilizes the training model to convert the semantic sequence into an integer token sequence as an input sequence. Each integer token index in the integer token sequence corresponds to a specific semantic description. Next, the encoder 211 utilizes the training model and the number of semantic fields to convert the integer token sequence into a channel dimensional vector. In detail, in the stage of Block B32, the encoder 211 converts the input sequence into a word embedding vector with a high feature dimension by the word embedding layer (such as Word2Vec), and then in the stage of Block B33, the encoder 211 compresses the word embedding vector into a compression sequence according to the length of the word embedding vector of the input sequence, and inputs the compression sequence into the training model for processing. The training model may include a Bi-LSTM neural network model, such that the encoder 211 can obtain the dependencies between the features corresponding to the channel dimension vector by the Bi-LSTM network mechanism.

In some embodiments, the control message includes DCI. The 3GPP specifications define a variety of formats for the DCI, including DCI format 1_0, DCI format 1_1, and/or other formats not listed but also applicable in the present disclosure. For example, Table 1 shows the contents of the DCI format 1_0.

TABLE 1

| | Number of |
|---|---|
| Field | Bits |
| Identifier for DCI formats | 1 |
| Frequency domain resource assignment | Variable |
| Time domain resource assignment | 4 |
| Virtual resource block (VRB) to physical | 1 |
| resource block (PRB) mapping | |
| Modulation and coding scheme (MCS) | 5 |
| New data indicator | 1 |
| Redundancy version | 2 |
| Number of hybrid automatic repeat request (HARQ) | 4 |
| process | |
| Downlink assignment index | 2 |
| Transmit power control (TPC) command for physical | 2 |
| uplink control channel (PUCCH) | |
| PUCCH resource indicator | 3 |
| Physical downlink shared channel (PDSCH) to HARQ | 3 |
| feedback timing indicator | |

As shown in Table 1, the DCI format 1_0 includes 12 fields. If the control message includes the DCI format shown in Table 1, these 12 fields are respectively used as semantic fields of the control message, i.e., the number of semantic fields of the control message is 12, and all the semantic sequences corresponding to all fields can form a set of reference data. For example, the set of reference data formed according to the content of Table 1 may include about 100 semantic sequences. In addition, the number of bits of the field “Identifier for DCI formats” is 1, whose binary value may be “0” or “1”, where the semantic sequence corresponding to “0” can be “From ue to gnb information.” while the semantic sequence corresponding to “1” can be “This message will send downlink information.”. That is, the field “Identifier for DCI formats” corresponds to 2 (i.e., 2¹) semantic sequences.

In some variant embodiments, the semantic fields with a low number of bits may be merged into a composite semantic field to reduce the number of semantic fields, thereby reducing the amount of data transmission. Taking Table 1 as an example, the three 1-bit fields, the three 2-bit fields, and the two 3-bit fields in the DCI in the format of Table 1 may be merged into a composite semantic field. As such, the number of fields in the DCI is reduced (e.g., from 12) to 5, and the number of semantic fields corresponding to the DCI is reduced (e.g., from 12) to 5. The number of bits of the signal transmitted by the transmitter 210 in the physical layer channel is determined by the parameters such as channel dimension and the number of semantic fields, and thus reduction of the number of semantic fields helps to reduce the amount of signal transmission (the transmission bits as well), thereby improving the transmission efficiency of the wireless communication system.

In addition, the length of semantic sequences and the number of semantic descriptions can be determined according to the system design requirements. Each semantic field may generate plural semantic sequences, in which all semantic descriptions may be a set of data used to generate the training model, i.e., the set of reference data. In some embodiments, the encoder 211 may convert a K-bit semantic field to one of 2^{K} semantic sequences. In the training phase, the transmitting end and the receiving end are iteratively trained using 2^{K} semantic sequences. Specifically, the transmission end may establish K tables, each of which corresponding to a K-bit semantic field, i.e., 2^{K} semantic sequences. For example, a 1-bit information field corresponds to 2 semantic sequences, a 2-bit information field corresponds to 4 semantic sequences, etc. Then, for example, bilingual evaluation understudy (BLEU) can be used to evaluate the similarity of the semantic sequences respectively on the transmitting end and the receiving end.

In some embodiments, similar to the transmitting end 110 of FIG. 2, the encoder 211 includes a JSCC encoder which encodes the control message by combining source coding and channel coding.

In the stage of Block B34, the normalizer 212 is configured to normalize the channel dimension vector output by the encoder 211 to generate a normalized channel dimension vector. The normalization by the normalizer 212 can balance the significance (or weight) of each feature in the channel dimension vector output by the encoder 211, and can help to avoid the problem of gradient disappearance or gradient explosion in the training model, such that the output of each neuron in the training model is maintained in a stable vector range.

In the stage of Block B35, the binarizer 213 is configured to binarize the normalized channel dimension vector. The representation of the fixed-point number(s) generated via the binarization by the binarizer 213 may be varying. The fixed-point number has a bit length, for example, the fixed-point number of 16 bits means the fixed-point number has a bit length of 16. The binarization may be performed by using one of the following methods (1)-(2).

Method (1): Convert the floating-point numbers within the range of −1 to less than 1 (i.e. [−1,1)) into a fixed-point number in a binary fixed-point format (i.e., a Q format) in Q3 (consisting of 4-bit binary digits), Q7 (consisting of 8-bit binary digits), or Q15 (consisting of 16-bit binary digits) to reduce the amount of data transmission. Taking Q15 as an example, after multiplying the floating-point number −0.7850 by 2¹⁵, the nearest integer is obtained, i.e., round (−0.7850×2¹⁵)=−25722, and then the obtained integer is converted into a binary fixed-point number, i.e., −25722=[1,0,0,1,1,0,1,1,1,0,0,0,0,1,1,0], where round(·) represents a round function. Another similar format (e.g., Q31) can also be used.

Method (2): Convert a floating-point number within the range between −2 and 2 (i.e., (−2,2)) into a 16-bit format, in which the first 5 bits represent redundant sign bits, the 6th to 10th bits are redundant integer bits, and the last 6 bits are decimal bits. In the 16-bit format, the first 5 bits are redundant sign bits of the same value (i.e., 00000 or 11111, in which the former represents a positive floating-point number while the latter represents a negative floating-point number), and the 6th to 10th bits are redundant integer bits of the same value (i.e., 11111 or 00000, in which the former represents the integer “1” and the latter represents the integer “0”). For example, according to this method, the fixed-point number obtained by converting a floating-point number −0.7443 is [1,1,1,1,1,0,0,0,0,0,1,0,1,1,1,1]. The advantages of this method are the amount of transmission can be reduced, the channel fault tolerance can be increased, and the protection of higher significant bits of the floating-point numbers can be enhanced. The number of bits, the number of redundant bits corresponding to the sign bits and the integer bits, and the number of decimal bits after the conversion can be modified according to the design requirements.

However, the embodiments of the present disclosure may optionally adopt another suitable binarization method, and is not limited to the above methods (1)-(2).

In the stage of Block B36, the RF circuit 214 is configured to modulate the fixed-point number to an RF signal RFS1 and transmit the RF signal RFS1 on a wireless channel to a receiving end. The RF circuit 214 may transmit the RF signals through single or multiple antennas.

In some embodiments, before the RF circuit 214 transmits the RF signal RFS1 to the receiving end, the encoder 211 encodes a setting message into setting parameter data, and the RF circuit 214 modulates the setting parameter data into an RF signal RFS2 and transmits the RF signal RFS2 to the same receiving end through the wireless channel, such that the receiving end can demodulate and decode the RF signal RFS2 to obtain the setting message and process the RF signal RFS1 according to the content of the setting message. The setting message may include a channel dimension, a bit length of the fixed-point number, the number of semantic fields, and/or another content that can be used by the receiver to demodulate and decode the RF signal RFS1.

In addition, in some embodiments, the encoder 211 may determine the channel dimension, the bit length of the fixed-point number, the number of semantic fields, the binarization method, etc., according to the channel environment quality where the transmitter 210 is located (such as degree of noise interference, multipath attenuation), but is not limited thereto. In some embodiments, the encoder 211 may determine the bit length of the fixed-point number according to the channel environment where the transmitter 210 is located, and the channel dimension may be determined according to the parameters of the training model set in the training phase, and the number of semantic fields may be determined according to the number of fields of the set of reference data selected in the training phase.

In the receiver 220, the RF circuit 221 is configured to perform receptions over the wireless channel and demodulate the received RF signal RFS1 into corresponding fixed-point numbers. Similar to the RF circuit 214 of the transmitter 210, the RF circuit 221 can also receive the RF signals through single or multiple antennas.

In the stage of Block B37, the de-binarizer 222 is configured to de-binarize the fixed-point number to generate channel dimension vectors according to the bit length. The de-binarizer 222 functionally corresponds to the binarizer 213. For example, if the binarizer 213 is configured to convert a floating-point number representing a channel dimension vector into fixed-point number in Q15 format, then accordingly the de-binarizer 222 converts the fixed-point numbers in Q15 format back to the floating-point representing the channel dimension vector. Those having ordinary skill in the art can directly understand according to the binarizer 213 described above, that the de-binarizer 222 de-binarizes the fixed-point number in a backward manner to convert the fixed-point number into a floating-point channel dimension vector.

In the stage of Block B38, the decoder 223 is configured to utilize the training model to decode the channel dimension vector into a control message that includes a control plane MAC layer message or a control plane physical layer message according to the channel dimension. The training model may include (e.g., may be) a LSTM neural network model, such as a unidirectional LSTM neural network model, so that the decoder 223 can sequentially generate semantic descriptions by the unidirectional LSTM network mechanism and generate the next semantic description at each time point according to the previous input and hidden state. After all semantic descriptions are decoded, in the stage of Block B39, the semantic similarity is evaluated by utilizing BLEU to determine which one of the semantic sequences at the transmitting end is closest to the restored semantic sequence, so as to complete the generation of the semantic sequence as an output sequence, i.e., complete the semantic message transmission.

In some embodiments, similar to the receiving end 120 in FIG. 2, the decoder 223 includes a JSCC decoder which decodes the channel dimension vector by combining source decoding and channel decoding to obtain a control message.

Corresponding to the transmitter 210, in some embodiments, before the RF circuit 221 receives the RF signal RFS1, the RF circuit 221 receives the RF signal RFS2 over the wireless channel and demodulates the RF signal RFS2 into setting parameter data, and the decoder 223 decodes the setting parameter data to obtain a setting message and processes the RF signal RFS1 according to the content of the setting message. The setting message may include a channel dimension, a bit length of the fixed-point number, the number of semantic fields, and/or another content that can be used by the RF circuit 221, the de-binarizer 222 and the decoder 223 to demodulate and decode the RF signal RFS1.

The following is an example of wireless communication between the transmitter 210 and the receiver 220. In the transmitter 210, firstly the encoder 211 encodes the control message such as “This message will send downlink information.” to generate integer token indices “7”, “118”, “41”, “122”, “110”, and “18” each of which respectively corresponds to the semantic descriptions “This”, “message”, “will”, “send”, “downlink”, and “information” in the control message, with an integer token index “2” corresponding to “.” in the control message to indicate the end of the control message, and converts all integer token indices sequentially into an integer token sequence [7,118,41,122,110,18,2]. A channel dimension vector [−0.3484,5.2276,7.9998,−8.6602,−6.5422,−7.2690,4.4938,−7.8044] is obtained after the integer token sequence [7,118,41,122,110,18,2] is transformed. Next, the normalizer 212 normalizes this channel dimension vector to obtain a normalized channel dimension vector [−0.0376, 0.5645, 0.8627, −0.9325, −0.7065, −0.7850, 0.4853, −0.8428]. The binarizer 213 then binarizes the normalized channel dimension vector in Q15 format to obtain a set of fixed-point numbers [1,1,1,1,1,0,1,1,0,0,1,0,1,1,1,1], [0,1,0,0,1,0,0,0,0,1,0,0,0,0,1,0], [0,1,1,0,1,1,1,0,0,1,1,0,1,1,0,1], [1,0,0,0,1,0,0,0,0,1,0,0,1,1,0,0], [1,0,1,0,0,1,0,1,1,0,0,1,0,0,1,0], [1,0,0,1,1,0,1,1,1,0,0,0,0,1,1,0], [0,0,1,1,1,1,1,0,0,0,0,1,1,1,0,1], [1,0,0,1,0,1,0,0,0,0,1,0,0,0,0,0]], and the RF circuit 214 modulates the fixed-point numbers into an RF signal and transmits the RF signal to the receiver 220 through a wireless channel. In the receiver 220, firstly the RF circuit 221 demodulates the received RF signal into a set of fixed-point numbers [[1,1,1,1,1,0,1,1,0,0,1,0,1,1,1,1], [0,1,0,0,0,0,0,0,0,1,0,1,0,0,1,0], [0,1,1,0,1,1,1,0,0,1,1,0,1,1,0,1], [1,0,0,0,1,0,0,0,0,1,0,0,1,1,0,0], [1,0,1,0,0,1,0,1,1,0,0,1,0,0,1,1], [0,0,0,1,1,0,1,1,1,0,0,0,0,1,1,0], [0,0,1,1,1,1,1,0,0,0,0,1,1,1,0,1], [1,0,0,1,0,1,0,0,0,0,1,0,0,0,0,0]]. Due to noise in the wireless channel, multipath degradation and/or other factors, the fixed-point numbers obtained after the demodulation has 4 bits different from the fixed-point numbers generated by the binarizer 213 of the transmitter 210. The De-binarizer 222 then de-binarizes the fixed-point numbers to obtain a channel dimensional vector [−0.0376, 0.5025, 0.8627, −0.9352, −0.7065, 0.2150, 0.4853, −7.8044]. Finally, the decoder 223 decodes the channel dimension vector to generate an integer token sequence [7,118,41,122,110,18,2]. Because the design of the transmitter 210 and the receiver 220 has built-in fault-tolerance ability, the decoder 223 can decode to obtain the same integer token sequence as that in the transmitter 210 even if the channel dimension vector in the receiver 220 is not exactly the same as that in the transmitter 210. Since different integer token indices correspond to different semantic descriptions, the control message obtained by the decoding of the decoder 223 is the same as that in the transmitter 210, i.e., the correct message transmission is completed.

The transmitter 210 and the receiver 220 described above may be applied to a base station or an access point and a user equipment in a wireless network system (e.g., a cellular network, a local area network, or another suitable wireless circuit system) for control message transmissions. Taking the OpenAirInterface (OAI) Alliance's 5G NR Access Network as an example, the encoder 211, the normalizer 212, and the binarizer 213 of the transmitter 210 may be embedded between the MAC layer and the PHY layer (physical layer) in the protocol stack of an OAI Next Generation base station, and the de-binarizer 222 and the decoder 223 of the receiver 220 may be embedded between the MAC layer and the PHY layer in the protocol stack of an OAI Next Generation user equipment, both of which are configured to process the control plane messages in the protocol stack. For control message transmissions in which the channel dimension, the bit length of the fixed-point number, and the number of semantic field being respectively set 8, 16, and 12 and a channel environment with the BER of about 3%, the successful rate of control message transmissions between the transmitter 210 and the receiver 220 can reach 100%. In comparison with a conventional transmission method in which an aggregation level of 8 and a coding rate of ⅓ are required for achieving 100% successful control message transmissions in the same channel environment, the control message transmissions between the transmitter 210 and the receiver 220 according to the present disclosure can significantly reduce the number of data bits required. If the control message is encoded by the method of merging the semantic fields with a low number of bits (taking Table 1 as an example, merging three 1-bit fields, three 2-bit fields, and two 3-bit fields into a composite semantic field), the successful rate of control message transmissions can also reach 100% in a similar channel environment, and the number of data bits required for control message transmissions can be further reduced. In addition, if 2^{K} semantic sequences are used for control message encoding (taking Table 1 as an example, the maximum value of the bit length K of the semantic fields is 5), and if the bit length of the fixed-point numbers and the number of semantic fields are fixed, because the set of reference data is smaller (that is, the total number of the semantic sequences included is smaller, i.e., 2^{K} semantic sequences), this method can reduce the number of data bits required for message transmissions by the reduction of the channel dimension, and increase the successful rate of control message transmissions as well.

It is noted that the above model training can be performed by the encoder on any transmission end and the decoder on any receiving end, rather than being limited to the encoder on the transmitting end and the decoder on the receiving end that use the same model training for control message transmissions. In other words, the transmitting end and the receiving end for model training (e.g., the transmitting end 110 and the receiving end 120 in FIG. 2) may be different from the transmitting end and receiving end for control message transmissions (e.g., the transmitter 210 in FIG. 4A and the receiver 220 in FIG. 4A).

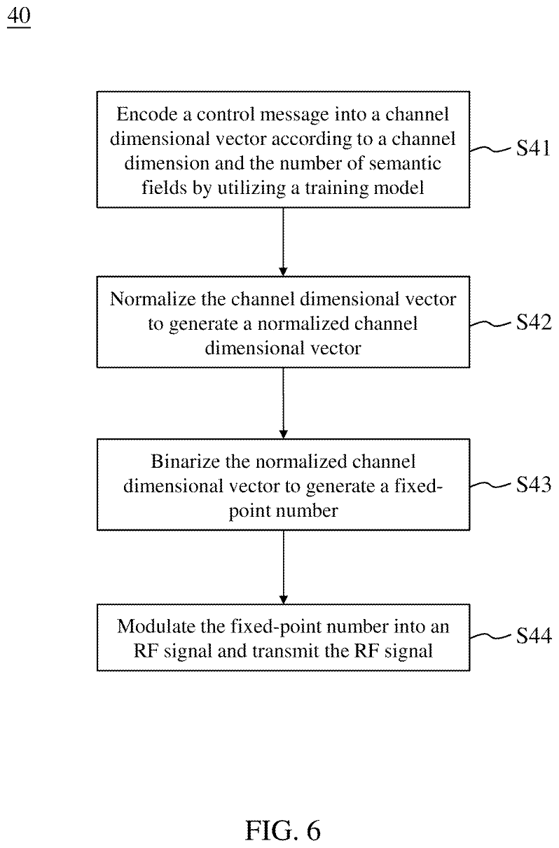

FIG. 6 is a flowchart of a wireless communication method 40 in accordance with some embodiments of the present disclosure. The wireless communication method 40 is suitable for a transmission end of a wireless communication system, such as the base station BS or the user equipment UE of the wireless communication system 10 in FIG. 1, the transmitter 210 in FIG. 4A, or another transmission apparatus with wireless communication functions. The flow of the wireless communication method 40 may be compiled into a program for execution, and includes the following steps. Step S41: Utilize the training model to encode the control message into a channel dimension vector according to a channel dimension and the number of semantic fields. The control message may include control plane MAC layer information or control plane physical layer information. Step S42: Normalize the channel dimension vector to generate a normalized channel dimension vector. Step S43: Binarize the normalized channel dimension vector to generate a fixed-point number. Step S44: Modulate the fixed-point number into a RF signal and transmit the RF signal. For example, if the wireless communication method 40 is used for the transmitter 210 of FIG. 4A, steps S41-S44 may be performed by the encoder 211, the normalizer 212, the binarizer 213, and the RF circuit 214 in the transmitter 210, respectively. The detailed description of each step S41-S44 in the wireless communication method 40 may refer to the description of the encoder 211, the normalizer 212, the binarizer 213, and the RF circuit 214, respectively, and will not be repeated herein.

As can be seen from the above description, the embodiments of the present disclosure adopt fault-tolerance encoding and decoding techniques based on semantic communication to provide the ability to cope with channel transmission errors for transmissions in various wireless channel environments. Particularly, in comparison with the conventional wireless communication systems, the embodiments of the present disclosure adopt a control message transmission mechanism based on semantic communication instead of a retransmission mechanism. In a high BER environment, the conventional wireless communication systems may have to retransmit the control message for multiple times on a transmitting end so that the control message cane be correctly decoded on a receiving end. However, in the control message transmission based on the embodiments of the present disclosure, the control message can still be correctly restored by extracting semantic features through semantic decoding without performing retransmission, thereby improving the usage efficiency of transmission resources.

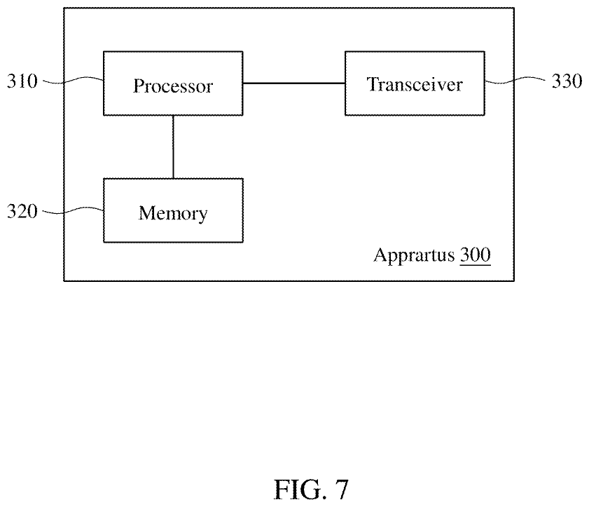

FIG. 7 is a schematic block diagram of an apparatus 300 in accordance with some embodiments of the present disclosure. Each user equipment UE and/or the base station BS in FIG. 1, the transmitting end 110 and/or the receiving end 120 in FIG. 2, the transmitter 210 in FIG. 4A, and/or the receiver 220 in FIG. 4B may have the same schematic block diagram as that of the apparatus 300. The apparatus 300 includes a processor 310, a memory 320, and a transceiver 330. The processor 310 may be, for example, a conventional processor, a digital signal processor (DSP), or an application-specific integrated circuit (ASIC), but is not limited thereto. The memory 320 may be any data storage device readable and executable by the processor 310. The memory 320 may be, for example, a subscriber identity module (SIM), a read-only memory (ROM), an erasable programmable ROM (EPROM), an electrically erasable programmable ROM (EEPROM), a random access memory (RAM), a CD-ROM, a hard disk drive, a solid-state drive, a flash, or another data storage device suitable for storing program codes, but is not limited thereto. The transceiver 330 may be an RF circuit used to perform wireless communications with another entity based on the operating result of the processor 310.

The processor 310 may be configured to perform operations such as the generation of the training model and the encoding/decoding of the control message in the present disclosure. For example, if the apparatus 300 is the transmitter 210 in FIG. 4A, the transceiver 330 corresponds to the RF circuit 214 to perform wireless communications with a receiver (e.g., the receiver 220 in FIG. 4B), and the processor 310 may be configured to perform the generation of the training model utilized by the transmitter 210, and/or the operations performed by the encoder 211, the normalizer 212, and the binarizer 213, and the memory 320 may be configured to store the programs for generating the training model, encoding, normalization, and/or binarization.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A transmitter for wireless communications, comprising:
an encoder configured to encode a control message into a channel dimensional vector according to a channel dimension and the number of semantic fields by utilizing a training model, wherein the control message comprises at least one of control plane media access control (MAC) layer information and control plane physical layer information;
a normalizer configured to normalize the channel dimensional vector to generate a normalized channel dimensional vector;
a binarizer configured to binarize the normalized channel dimensional vector to generate a fixed-point number; and
a radio frequency (RF) circuit configured to modulate the fixed-point number into a first RF signal and transmit the first RF signal.

2. The transmitter of claim 1, wherein the control message comprises downlink control information (DCI).

3. The transmitter of claim 1, wherein the training model comprises a bi-directional long-short term memory (Bi-LSTM) neural network model.

4. The transmitter of claim 1, wherein the encoder comprises a joint source-channel coding (JSCC) encoder.

5. The transmitter of claim 1, wherein the fixed-point number comprises a plurality of redundant sign bits, a plurality of redundant integer bits, and a plurality of decimal bits.

6. The transmitter of claim 1, wherein the encoder is configured to generate at least one of the channel dimension, a bit length of the fixed-point number, and the number of semantic fields according to a channel environment where the transmitter is located.

7. The transmitter of claim 6, wherein before the RF circuit transmits the first RF signal to a receiving end, the encoder encodes a setting message comprising at least one of the channel dimension, the bit length of the fixed-point number, and the number of semantic fields into setting parameter data, and the RF circuit modulates the setting parameter data into a second RF signal and transmits the second RF signal to the receiving end.

8. A receiver for wireless communications, comprising:
an RF circuit configured to receive a first RF signal and demodulate the first RF signal into a fixed-point number;
a de-binarizer configured to de-binarize the fixed-point number to generate a channel dimensional vector; and
a decoder configured to decode the channel dimensional vector into a control message according to a channel dimension and the number of semantic fields by utilizing a training model, wherein the control message comprises a control plane MAC layer message or a control plane physical layer message.

9. The receiver of claim 8, wherein the control message comprises DCI.

10. The receiver of claim 8, wherein the training model comprises a long-short term memory (LSTM) neural network model.

11. The receiver of claim 8, wherein the decoder comprises a JSCC decoder.

12. The receiver of claim 8, wherein the fixed-point number comprises a plurality of redundant sign bits, a plurality of redundant integer bits, and a plurality of decimal bits.

13. The receiver of claim 8, wherein before the RF circuit receives the first RF signal, the RF circuit receives a second RF signal and demodulates the second RF signal into setting parameter data, and the decoder decodes the setting parameter data to obtain a setting message comprising the channel dimension, a bit length of the fixed-point number, and the number of semantic fields.

14. A wireless communication method for a transmitting end, the wireless communication method comprising:
encoding a control message into a channel dimensional vector according to a channel dimension and the number of semantic fields by utilizing a training model, wherein the control message comprises at least one of control plane MAC layer information and control plane physical layer information;
normalizing the channel dimensional vector to generate a normalized channel dimensional vector;
binarizing the normalized channel dimensional vector to generate a fixed-point number; and
modulating the fixed-point number into a first RF signal and transmitting the first RF signal.

15. The wireless communication method of claim 14, wherein the training model comprises a Bi-LSTM neural network model.

16. The wireless communication method of claim 14, wherein encoding the control message comprises using a JSCC to encode the control message.

17. The wireless communication method of claim 14, wherein the control message comprises DCI.

18. The wireless communication method of claim 14, wherein the fixed-point number comprises a plurality of redundant sign bits, a plurality of redundant integer bits, and a plurality of decimal bits.

19. The wireless communication method of claim 14, wherein at least one of the channel dimension, a bit length of the fixed-point number, and the number of semantic fields is dependent on a channel environment where the transmitting end is located.

20. The wireless communication method of claim 19, further comprising:
before transmitting the RF signal to a receiving end, transmitting a setting message comprising at least one of the channel dimension, the bit length of the fixed-point number, and the number of semantic fields to the receiving end.
